(19) United States
(12) Patent Application Publication
(10) Pub. No.: US 2020/0095947 A1
(43) Pub. Date: Mar. 26, 2020

(54) VALVE TIMING CHANGING DEVICE

(71) Applicant: MIKUNI CORPORATION, Tokyo (JP)

(72) Inventor: Riki MURASAKA, Kanagawa (JP)

(73) Assignee: MIKUNI CORPORATION, Tokyo (JP)

(21) Appl. No.: 16/472,903

(22) PCT Filed: Dec. 18, 2017
(86) PCT No.: PCT/JP2017/045292

§ 371 Date: Jun. 24, 2019

(30) Foreign Application Priority Data
Dec. 28, 2016 (JP) 2016-256885

(51) Int. Cl. F02D 13/02; F01L 13/00

(52) U.S. Cl. CPC F02D 13/02; F01L 2001/34463; F01L 13/0015

(57) ABSTRACT

This valve timing changing device is provided with: a vane rotor which is connected to integrally rotate with a camshaft about the same axis; a housing rotor which houses the vane rotor and is capable of relative rotation in a predetermined angle range about the axis; and a torsion coil spring which has a coil part for biasing the vane rotor to rotate in one direction with respect to the housing rotor. The vane rotor has a first inner guide part inserted therein from one end of the coil part, and the housing rotor has a second inner guide part inserted therein from the other end of the coil part.

### BACKGROUND

### Technical Field

The present invention relates to a valve timing changing device that changes an opening/closing timing (a valve timing) of an intake valve or an exhaust valve of an internal combustion engine depending on operating conditions.

### Description of Related Art

As a valve timing changing device according to the related art, a valve timing changing device including a shoe housing that rotates in synchronization with a crank shaft, a vane rotor that can integrally rotate with a cam shaft and rotate in a predetermined angle range relative to the shoe housing, a torsion coil spring that biases the vane rotor to rotate in one direction with respect to the shoe housing, and a coil cover with a cylindrical shape that is disposed around the torsion coil spring is known (for example, see Patent Literature 1).

In this device, the torsion coil spring includes a coil portion, a first arm that extends from one end of the coil portion and is locked to the vane rotor, and a second arm that extends from the other end of the coil portion and is locked to the shoe housing.

The coil cover is disposed around the coil portion to prevent the coil portion from interfering with the shoe housing and the vane rotor.

However, in the configuration in which the torsion coil spring is disposed as described above, when the torsion coil spring with specifications of a low torque and a low spring constant is twisted, there is concern that the coil portion will fall down inward and a desired torque will not be able to be acquired.

When the torsion coil spring is twisted, a part of the coil portion that has fallen down will come into contact with a bolt for fastening the vane rotor, a seat surface thereof, or the like and cause looseness of the bolt, damage due to contact of the coil portion, occurrence of an abnormal torque due to contact of the coil portion, or the like.

On the other hand, when a torsion coil spring with a high torque and a high spring constant is employed to prevent the coil portion from falling down, a degree of freedom in setting a torque decreases.

### RELATED ART

### Patent Literature

### [Patent Literature 1]

Japanese Patent Laid-open Publication No. 2002-295208

### SUMMARY

### Technical Problem

The present invention is made to solve the problems in the related art and provides a valve timing changing device that can ensure an expected function based on a torsion coil spring.

### Solution to Problem

A valve timing changing device according to the present invention is a valve timing changing device that changes an opening/closing timing of an intake valve or an exhaust valve which is driven by a cam shaft, including: a vane rotor that is connected to the cam shaft to integrally rotate with the cam shaft about a same axis; a housing rotor that accommodates the vane rotor and is capable of relative rotation in a predetermined angle range about the axis; and a torsion coil spring that includes a coil portion such that the coil portion biases the vane rotor to rotate in one direction relative to the housing rotor. The vane rotor includes a first inner guide portion that is inserted into the coil portion from one end of the coil portion. The housing rotor includes a second inner guide portion that is inserted into the coil portion from the other end of the coil portion.

The valve timing changing device having the above-mentioned configuration may employ a configuration in which the first inner guide portion and the second inner guide portion are configured to have a cylindrical outer circumferential surface.

The valve timing changing device having the above-mentioned configuration may employ a configuration in which the housing rotor includes an opening through which a bolt for fastening the vane rotor to the cam shaft passes and includes the second inner guide portion around the opening, and the vane rotor includes a through-hole through which the bolt passes and includes the first inner guide portion around the through-hole.

The valve timing changing device having the above-mentioned configuration may employ a configuration in which the vane rotor includes a first ring-shaped concave portion that receives one end of the coil portion around the first inner guide portion, and the housing rotor includes a second ring-shaped concave portion that receives the other end of the coil portion around the second inner guide portion.

The valve timing changing device having the above-mentioned configuration may employ a configuration in which the second ring-shaped concave portion or the first ring-shaped concave portion is configured such that a seat surface for receiving the coil portion is located on a spiral-shaped inclined surface with a predetermined angle.

The valve timing changing device having the above-mentioned configuration may employ a configuration in which the torsion coil spring includes a first arm that extends inward in a radial direction from the coil portion and a second arm that extends outward in the radial direction from the coil portion, the vane rotor includes a first locking recessed portion that locks the first arm in an area which is visible via an opening of the housing rotor, and the housing rotor includes a second locking recessed portion that locks the second arm around the opening.

The valve timing changing device having the above-mentioned configuration may employ a configuration in which the torsion coil spring is set to be closest to the first inner guide portion and the second inner guide portion in a state in which the torsion coil spring is twisted a predetermined quantity and a coil diameter of the coil portion is decreased.

The valve timing changing device having the above-mentioned configuration may employ a configuration in which the second inner guide portion and the first inner guide portion are configured to be in close contact with each other in a direction of the axis.

The valve timing changing device having the above-mentioned configuration may employ a configuration in which the housing includes a front housing that has a bottom and the opening and a rear housing that is coupled to the front housing in a direction of the axis, and the torsion coil spring is disposed between the front housing and the vane rotor.

### Advantageous Effects of Invention

With the valve timing changing device having the above-mentioned configuration, it is possible to obtain a valve timing changing device that can prevent a torsion coil spring from falling down and ensure an expected function.

### BRIEF DESCRIPTION OF THE DRAWINGS

FIG. 1 is a perspective view illustrating an appearance of a valve timing changing device according to the present invention.

FIG. 2 is an exploded perspective view illustrating the valve timing changing device illustrated in FIG. 1.

FIG. 3 is a sectional view illustrating a state in which the valve timing changing device illustrated in FIG. 1 is attached to a cam shaft of an engine.

FIG. 4 is a sectional view illustrating a state in which the valve timing changing device illustrated in FIG. 1 is attached to a cam shaft of an engine.

FIG. 5 is a rear view illustrating a front housing of a housing rotor which is a part of the valve timing changing device illustrated in FIG. 1 when seen from the rear side.

FIG. 6A is a rear view illustrating a seat surface in a second ring-shaped concave portion of the front housing illustrated in FIG. 5.

FIG. 6B is a diagram illustrating an inclination of the seat surface in the second ring-shaped concave portion of the front housing illustrated in FIG. 5.

FIG. 7 is a front view illustrating a state of a torsion coil spring in a state in which a vane rotor which is a part of the valve timing changing device according to the present invention is located at a maximum-retarded-angle-position.

FIG. 8 is a sectional view illustrating a state of the torsion coil spring in the state in which the vane rotor which is a part of the valve timing changing device according to the present invention is located at the maximum-retarded-angle-position.

FIG. 9 is a front view illustrating a state of the torsion coil spring in a state in which the vane rotor which is a part of the valve timing changing device according to the present invention is located at a maximum-advanced—angle-position.

FIG. 10 is a sectional view illustrating a state of the torsion coil spring in the state in which the vane rotor which is a part of the valve timing changing device according to the present invention is located at the maximum—advanced-angle-position.

FIG. 11 is a sectional view illustrating another embodiment of the valve timing changing device according to the present invention.

### DESCRIPTION OF THE EMBODIMENTS

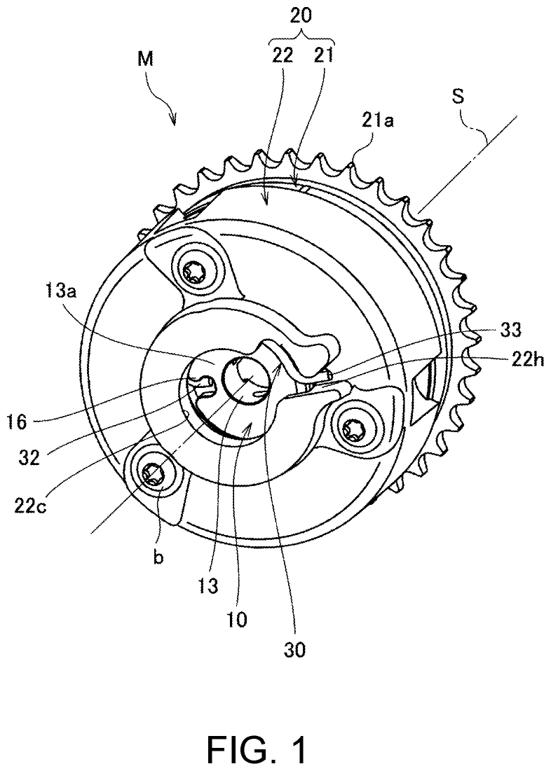

Hereinafter, an embodiment of the present invention will be described with reference to FIGS. 1 to 10 of the accompanying drawings.

A valve timing changing device M according to this embodiment includes a vane rotor 10 that is connected to a cam shaft CS to rotate about the same axis S, a housing rotor 20 that can accommodate the vane rotor 10 and perform relative rotation in a predetermined angle range about the axis S, a torsion coil spring 30 that biases the vane rotor 10 to rotate in one direction relative to the housing rotor 10, and a lock mechanism 40 that locks the vane rotor 10 to the housing rotor 20.

The lock mechanism 40 includes a lock pin 41, a coil spring 42, and a cylindrical holder 43.

Here, the housing rotor 20 serves to move along with rotation of a crank shaft via a chain or the like and to transmit a rotational driving force of the crank shaft to the cam shaft CS via the vane rotor 10.

The cam shaft CS is supported to rotate about the axis S by bearings which are formed in a cylinder head of an engine, that is, is supported to rotate in a direction of an arrow CR, and drives opening/closing of an intake valve or an exhaust valve of the engine by a cam operation.

The cam shaft CS includes a journal portion CS1 that is supported by bearings, a cylinder portion CS2 that rotatably supports the housing rotor 20, an advanced-angle-passage CS3 that performs supply and discharge of a hydraulic oil, a retarded-angle-passage CS4 that performs supply and discharge of a hydraulic oil, and a female screw portion CS5 that is fastened to a bolt B.

The valve timing changing device M performs a function of changing a valve timing in the engine by fastening the vane rotor 10 to the cam shaft CS using a bolt B and connecting the vane rotor 10 to an oil pressure control system OCS that controls a flow of a hydraulic oil (a lubricant).

The vane rotor 10 includes a front surface 10a and a rear surface 10b that face the direction of the axis S, three vane portions 11, a hub portion 12 having a columnar shape, a through-hole 13, a seat surface 13a for a bolt B that is formed in a ring-shaped convex portion defining the through-hole 13, a first inner guide portion 14, a first ring-shaped concave portion 15, a first locking recessed portion 16, a fitting hole 17 to which the lock mechanism 40 is fitted, a pressure adjustment hole 17a, a passage 17b, a retarded-angle-passage 18, a fitting concave portion 19 to which the cam shaft CS is fitted, a seal member that is inserted into the tip of the vane portions 11, and a positioning hole into which a positioning pin of the cam shaft CS is inserted.

The three vane portions 11 are arranged at substantially equal intervals with respect to the hub portion 12.

The through-hole 13 is formed in a cylindrical shape penetrating from the front surface 10a to the rear surface 10b on the axis S such that the bolt B can closely pass therethrough.

The first inner guide portion 14 is formed as a ring-shaped convex portion defining the through-hole 13, that is, a cylindrical outer circumferential surface with a predetermined outer diameter around the through-hole 13, on the front surface 10a.

The first inner guide portion 14 is formed to enter the inside of one end 31a of a coil portion 31 of the torsion coil spring 30.

That is, since the first inner guide portion 14 is formed in a shape including the cylindrical outer circumferential surface, the inner circumferential surface of the coil portion 31 having a cylindrical shape can be uniformly guided. Accordingly, it is possible to prevent the coil portion 31 from falling down and to position the coil portion 31 at a predetermined position.

The first ring-shaped concave portion 15 is formed to receive the one end 31a of the coil portion 31 of the torsion coil spring 30 in the vicinity of the first inner guide portion 14.

That is, by fitting the one end 31a of the coil portion 31 into the first ring-shaped concave portion 15, it is possible to reliably prevent positional shift of the coil portion 31 in cooperation with the first inner guide portion 14 and to decrease the thickness of the device in the direction of the axis S.

The first locking recessed portion 16 is formed in a groove shape with a decreased thickness directed inward in the radial direction perpendicular to the axis S such that the first arm 32 of the torsion coil spring 30 is locked in an area which is visible from the outside via the opening 22c of the housing rotor 20 and which is inside the first inner guide portion 14 in the radial direction.

According to this configuration, when the torsion coil spring 30 is assembled, the first arm 32 can be locked to the first locking recessed portion 16 while the first arm 32 is seen via the opening 22c, for example, using a predetermined jig or the like which is inserted via the opening 22c of the housing rotor 20. That is, the torsion coil spring 30 can be easily assembled while accommodated in the housing rotor 20.

The fitting hole 17 is formed such that the cylindrical holder 43 of the lock mechanism 40 is fitted thereto.

The pressure adjustment hole 17a is formed to open toward the front surface 10a and is connected to a long groove 17a1 communicating with the outside.

The passage 17b is formed to open to the side surface of one vane portion 11 and to communicate with a retarded-angle-chamber 20b.

A retarded-angel-passage 18 is formed to communicate with a retarded-angle-passage CS4 for the purpose of supply and discharge of a hydraulic oil to and from the retarded-angle-chamber 20b.

The fitting concave portion 19 is formed to form a cylindrical concave portion on the rear surface 10b side of the vane rotor 10 and a front end portion of the cam shaft CS is inserted thereinto.

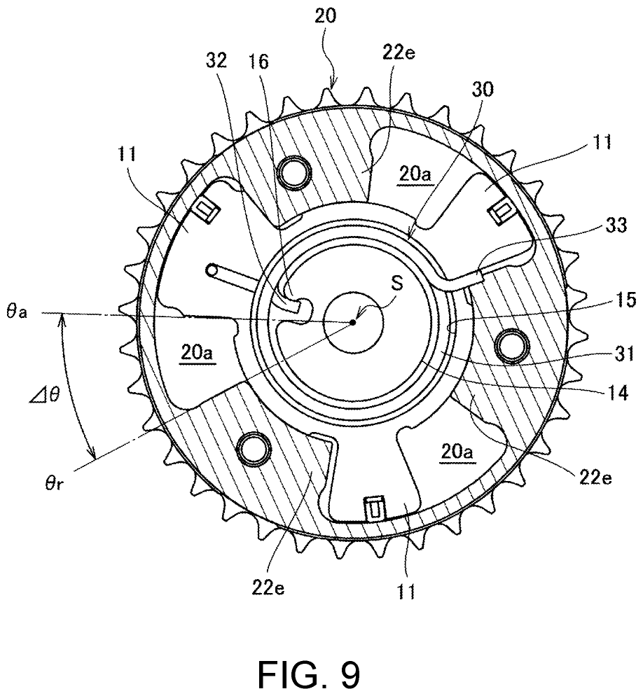

The vane rotor 10 is accommodated in a chamber of the housing rotor 20 such that it is capable of relative rotation in a predetermined angle range Δθ (see FIG. 9), partitions the chamber into an advanced-angle-chamber 20a and a retarded-angle-chamber 20b, and is connected to the cam shaft CS by the bolt B to integrally rotate with the cam shaft CS.

The housing rotor 20 has a two-partition structure including a rear housing 21 having substantially a disc shape and a front housing 22 with a bottomed cylindrical shape that is coupled to the front surface side of the rear housing 21.

The housing rotor 20 accommodates the vane rotor 10 such that it is capable of relative rotation in a predetermined angle range Δθ, that is, in an angle range between a maximum-advanced-angle-position θa and a maximum-retarded-angle-position θr, and is formed such that the chamber is partitioned into the advanced-angle-chamber 20a and the retarded-angle-chamber 20b by the vane portions 11 of the vane rotor 10.

The rear housing 21 includes a sprocket 21a, an inner circumferential surface 21b, a front surface (an inner wall surface) 21c, an advanced-angle-passage 21d, a fitting hole 21e, a passage 21f, and three screw holes 21g into which bolts b are screwed.

The sprocket 21a is formed such that a chain for transmitting a rotation driving force of the crank shaft is wound thereon.

The inner circumferential surface 21b is formed to be rotatably fitted to the cylindrical portion CS2 of the cam shaft CS.

The front surface 21c is formed such that the rear surface 10b of the vane rotor 10 is in slidable contact therewith.

The advanced-angle-passage 21d is formed in a groove shape on the front surface 21c to communicate with the advanced-angle-passage CS3 of the cam shaft CS such that a hydraulic oil can be supplied to and discharged from the advanced-angle-chamber 20a.

The fitting hole 21e is formed on the front surface 21c such that the lock pin 41 included in the lock mechanism 40 is inserted thereinto.

The passage 21f is formed in a groove shape on the front surface 21c to communicate with the advanced-angle-passage 21d such that a hydraulic oil can be supplied to and discharged from the fitting hole 21e.

The front housing 22 is formed in a bottomed cylindrical shape including a cylindrical wall 22a and a front wall 22b and includes an opening 22c, three through-holes 22d through which the bolts b pass, three shoe portions 22e, a second inner guide portion 22f, a second ring-shaped concave portion 22g, a second locking recessed portion 22h, and a ring-shaped coupling portion 22i.

The opening 22c is formed in a shape including a circular shape centered on the axis S such that the bolt B can pass therethrough.

The three shoe portions 22e are formed on the inner wall surface side of the front wall 22b to protrude from the cylindrical wall 22a toward the center (the axis S) and to be arranged at equal intervals in the circumferential direction.

The second inner guide portion 22f is formed to include a cylindrical outer circumferential surface with a predetermined outer diameter on the inner wall surface side of the front wall 22b and around the opening 22c

The second inner guide portion 22f is formed to enter the inside of the other end 31b of the coil portion 31 of the torsion coil spring 30.

That is, since the second inner guide portion 22f is formed in a shape including the cylindrical outer circumferential surface, the inner circumferential surface of the coil portion 31 having a cylindrical shape can be uniformly guided. Accordingly, it is possible to prevent the coil portion 31 from falling down and to position the coil portion 31 at a predetermined position.

The second ring-shaped concave portion 22g is formed around the second inner guide portion 22f to receive the other end 31b of the coil portion 31 of the torsion coil spring 30.

That is, by inserting the other end 31b of the coil portion 31 into the second ring-shaped concave portion 22g, it is possible to reliably prevent positional shift of the coil portion 31 in cooperation with the second inner guide portion 22f and to decrease the thickness of the device in the direction of the axis S.

The second ring-shaped concave portion 22g includes a seat surface 22g1 that receives the other end 31b of the coil portion 31.

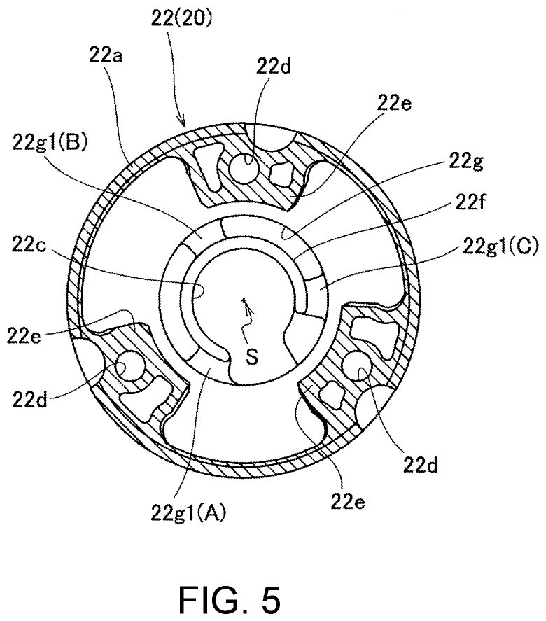

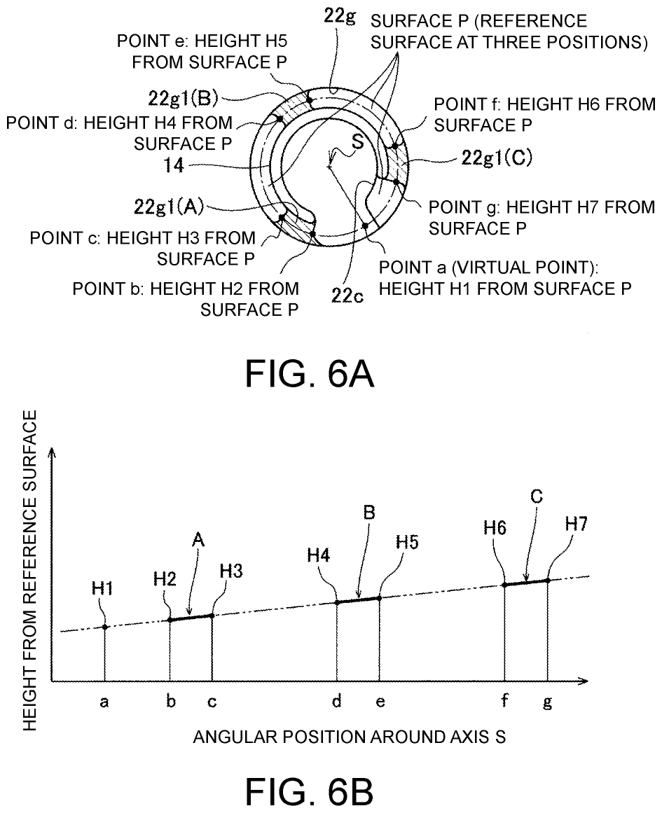

The seat surface 22g1 is formed by three areas A, B, and C which are arranged at equal intervals around the axis S as illustrated in FIGS. 5 and 6A.

As illustrated in FIG. 6B, the three areas A, B, and C are formed such that height positions H2, H3, H4, H5, H6, and H7 (H2<H3<H4<H5<H6<H7) protruding from a reference surface P in the direction of the axis S are located on a straight line with a predetermined inclination angle.

That is, the seat surface 22g1 is formed to be located on a spiral inclined surface with a predetermined angle.

Accordingly, since the end surface of the coil portion 31 is uniformly seated and supported on the seat surface 22g1 which is an inclined surface, it is possible to prevent the coil portion 31 from falling down using the seat surface 22g.

The second locking recessed portion 22i is formed in a groove shape directed in the radial direction perpendicular to the axis S with a decreased thickness such that the second arm 33 of the torsion coil spring 30 is locked around the opening 22c.

Accordingly, when the torsion coil spring 30 is assembled, the vane rotor 10 can be assembled into the housing rotor 20, for example, by disposing the torsion coil spring 30 inside the housing rotor 20, stretching the second arm 33 from inside to outside to be locked to the second locking recessed portion 22i, and inserting the torsion coil spring 30.

As described above, by locking the first arm 32 to the first locking recessed portion 16 while viewing the first arm 32 via the opening 22c using a predetermined jig or the like which is inserted through the opening 22c, it is possible to complete assembly of the torsion coil spring 30.

The torsion coil spring 30 includes a coil portion 31, a first arm 32 that extends inward in the radial direction from the coil portion 31 at one end 31a of the coil portion 31, and a second arm 33 that extends outward in the radial direction from the coil portion 31 at the other end 31b of the coil portion 31.

The coil portion 31 is formed in a spiral winding with a cylindrical shape having a predetermined diameter out of spring steel.

One end 31a of the coil portion 31 is fitted into the first ring-shaped concave portion 15 of the vane rotor 10, and the first inner guide portion 14 is inserted thereinto and guided.

The other end 31b of the coil portion 31 is fitted into the second ring-shaped concave portion 22g of the front housing 22, and the second inner guide portion 22f is inserted thereinto and guided.

The first arm 32 is disposed in an area which can be seen from the outside via the opening 22c of the housing rotor 20 and is locked to the first locking recessed portion 16 of the vane rotor 10.

The second arm 33 is locked to the second locking recessed portion 22h of the front housing 22 in an area which is visible from the outside of the housing rotor 20.

That is, the torsion coil spring 30 is disposed between the front housing 22 and the vane rotor 10, the coil portion 31 is fitted into the first locking recessed portion 16 and the second ring-shaped concave portion 22g, the inner circumferential surface of the coil portion 31 is guided by the first inner guide portion 14 and the second inner guide portion 22f from both sides in the direction of the axis S, the first arm 32 is locked to the first locking recessed portion 16, and the second arm 33 is locked to the second locking recessed portion 22h.

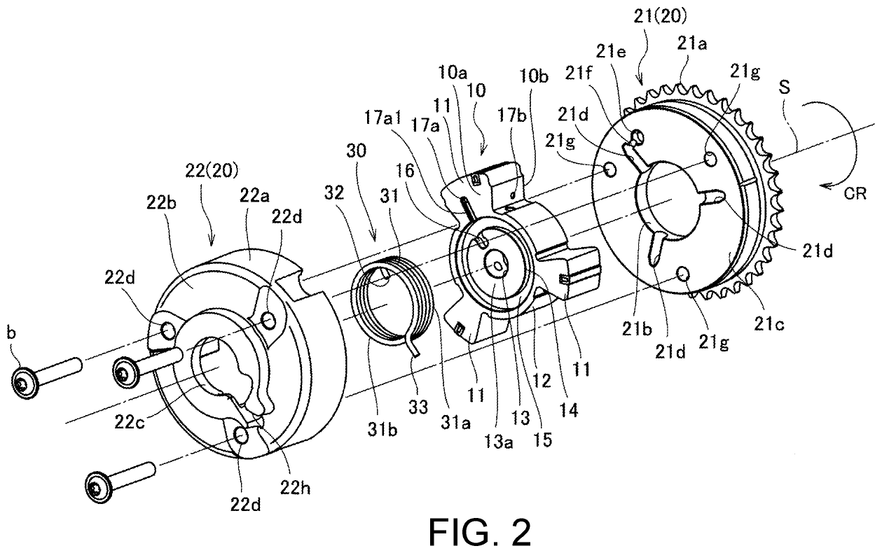

The torsion coil spring 30 biases the vane rotor 10 to rotate in an advanced-angle-direction, that is, in the direction of an arrow CR in FIGS. 2 to 4, relative to the housing rotor 20.

In this way, since the coil portion 31 of the torsion coil spring 30 is guided by the first inner guide portion 14 of the vane rotor 10 into which the one end 31a is inserted and is guided by the second inner guide portion 22f of the housing rotor 20 into which the other end 31b is inserted, it is possible to prevent the coil portion 31 from falling down and to stably generate a desired torque.

Accordingly, a torsion coil spring with a high torque and a high spring constant does not need to be employed to prevent the coil portion 31 from falling down and it is possible to enhance a degree of freedom in setting a torque value based on the torsion coil spring.

A component such as a coil cover in the related art is not necessary and it is thus possible to achieve simplification of the structure, a decrease in the number of components, a decrease in size of the device, a decrease in cost, and the like.

Particularly, since the torsion coil spring 30 is disposed in the vicinity of the bolt B and is also guided by the first inner guide portion 14 formed around the through-hole 13 and the second inner guide portion 22f formed around the opening 22c, it is possible to prevent the coil portion 31 from entering an arrangement area of the bolt B. Therefore, it is possible to prevent looseness of the bolt B due to mutual interference, damage of the torsion coil spring 30 due to interference with the bolt B, and the like and to ensure an expected function.

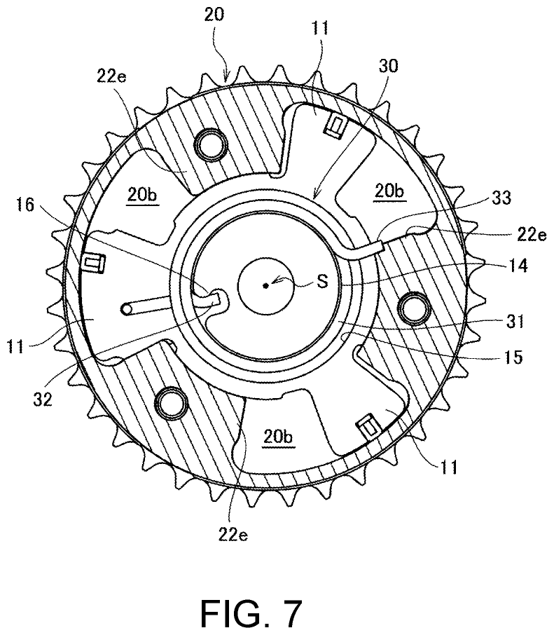

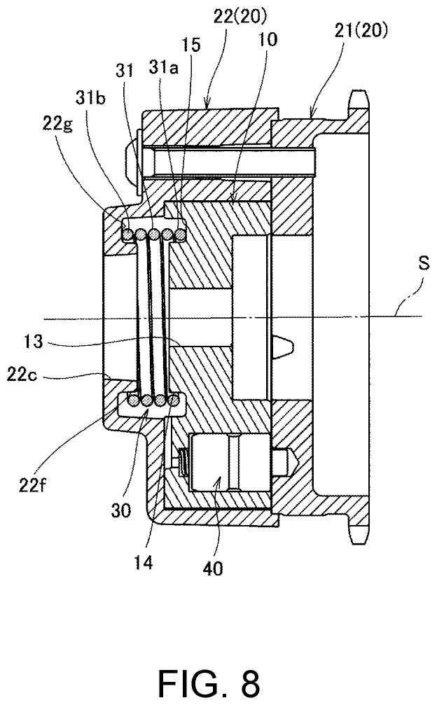

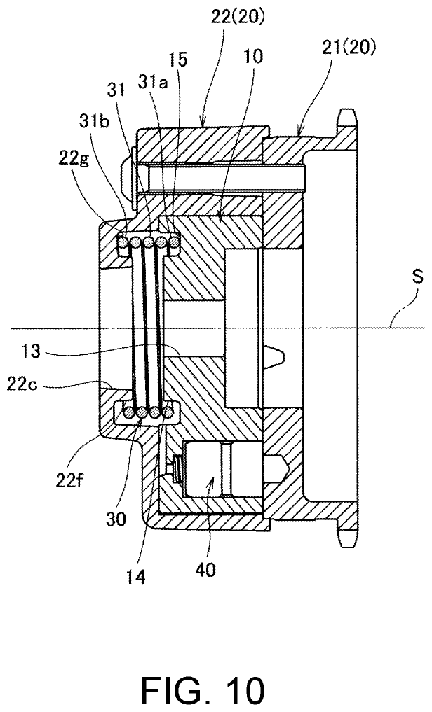

The torsion coil spring 30 positions the vane rotor 10 at the maximum-retarded-angle-position Or relative to the housing rotor 20 in a state in which the torsion coil spring 30 has been twisted a predetermined quantity and the coil diameter of the coil portion 31 has been decreased as illustrated in FIGS. 7 and 8, and positions the vane rotor 10 at the maximum-advanced-angle-position θa relative to the housing rotor 20 in a state in which the torsion coil spring 30 has been untwisted and the coil diameter thereof has been increased as illustrated in FIGS. 9 and 10.

That is, the torsion coil spring 30 is set to be closest to the first inner guide portion 14 and the second inner guide portion 22f in a state in which the torsion coil spring has been twisted a predetermined quantity and the coil diameter of the coil portion has been decreased as illustrated in FIG. 7. Accordingly, in a tense diameter-decreased state in which the torsion coil spring 30 is twisted and likely to fall down or the like, since the inside of the coil portion 31 is guided to be close by the first inner guide portion 14 and the second inner guide portion 22f, it is possible to reliably prevent the coil portion 31 from falling down.

The lock mechanism 40 includes a lock pin 41, a coil spring 42, and a cylindrical holder 53.

The lock pin 41 is formed to reciprocate in the direction of the axis S and to protrude from the rear surface 10b of the vane rotor 10 such that it can be inserted into the fitting hole 21e of the rear housing 21.

The coil spring 42 is disposed to apply a biasing force in a direction in which the lock pin 51 protrudes from the rear surface 10b of the vane rotor 10.

The cylindrical holder 43 is formed to hold the lock pin 41 biased by the coil spring 42 such that it can reciprocate and be fitted into the fitting hole 17 of the vane rotor 10.

Then, by causing the coil spring 52 to bias the lock pin 51 to be fitted into the fitting hole 21e of the housing rotor 20 in a state in which a hydraulic pressure of a hydraulic oil which is supplied via the passages 21f and 21d and presses the lock pin 51 has been lowered, the vane rotor 10 is locked at a maximum-retarded-angle-position Or in a predetermined angle range AO relative to the housing rotor 20.

On the other hand, when the hydraulic pressure added to the lock pin 51 is increased by the hydraulic oil which is guided via the oil passages 21f and 21d, the lock pin 51 retreats from the rear surface 10b of the vane rotor 10 to release the locked state.

The oil pressure control system OCS includes an oil pressure control valve 100 that controls a flow of a hydraulic oil ejected from a pump, an advanced-angle-side passage 101 that causes the oil pressure control valve 100 and the advanced-angle-passage CS3 to communicate with each other, a retarded-angle-side-passage 102 that causes the oil pressure control valve 100 and the retarded-angle-passage CS4 to communicate with each other, and a control means (not illustrated) that controls driving of the oil pressure control valve 100.

A method of attaching the valve timing changing device will be described below.

In advance, the front housing 22, the rear housing 21, the vane rotor 10 into which the lock mechanism 40 has been assembled, the torsion coil spring 30, three bolts b, and a predetermined jig are prepared.

First, the second arm 33 of the torsion coil spring 30 is locked to the second locking recessed portion 22h formed around the opening 22c of the front housing 22, the other end 31b of the coil portion 31 is fitted into the second ring-shaped concave portion 22g, and the second inner guide portion 22f is inserted thereinto from the other end 31b.

Subsequently, the first inner guide portion 14 is inserted from the one end 31a while the one end 31a of the coil portion 31 of the torsion coil spring 30 is being fitting into the first ring-shaped recessed portion 16, and the torsion coil spring 30 is inserted to fit the vane rotor 10 into the front housing 22.

Subsequently, the first arm 32 is locked to the first locking recessed portion 16 using the predetermined jig while viewing the first arm 32 from the front side of the front housing 22 via the opening 22c.

Thereafter, the front housing 22 into which the torsion coil spring 30 and the vane rotor 10 have been assembled is opposed and bonded to the rear housing 21, and both housings are fastened and fixed using the bolts b.

Accordingly, as illustrated in FIG. 1, the valve timing changing device M is completed.

Thereafter, the rear housing 21 of the housing rotor 20 is rotatably fitted into the cam shaft CS of an engine and the fitting concave portion 19 of the vane rotor 10 is bonded to the front end of the cam shaft CS.

Then, the bolt B is screwed into the female screw portion CS5 of the cam shaft CS via the opening 22c of the front housing 22 and the through-hole 13 of the vane rotor 10, and the vane rotor 10 is fixed to rotate integrally with the cam shaft CS.

Accordingly, the valve timing changing device M can be assembled into the cam shaft CS of a predetermined engine.

The operation of the valve timing changing device will be described below with reference to FIGS. 7 to 10.

In a state in which the engine has been stopped, as illustrated in FIGS. 7 and 8, a hydraulic oil in the advanced-angle-chamber 20a and the retarded-angle-chamber 20b is discharged and the vane rotor 10 positioned as the maximum-retarded-angle-position Or against the biasing force of the torsion coil spring 30.

The lock pin 41 of the lock mechanism 40 is fitted into the fitting hole 21e and the vane rotor 10 is locked to the housing rotor 20.

Accordingly, when the engine is started, it is possible to prevent rattling of the vane rotor 10 or the like and to smoothly start the engine.

Subsequently, when a hydraulic oil is supplied to a pressure receiving portion of the lock pin 41 via the passages 21d and 21f by starting the engine, the lock pin 41 is pressed by the hydraulic pressure and departs from the fitting hole 21e to release the locked state.

After the engine has been started, the oil pressure control valve 100 is appropriately switched and phase control is performed such that the vane rotor 10 (the cam shaft CS) is kept on the advanced-angle-side or the retarded-angle-side or at a predetermined angle position.

For example, in an advanced-angle-mode, a hydraulic oil in the retarded-angle-chamber 20b is discharged via the retarded-angle-passage CS4 and the retarded-angle-side-passage 102, and the hydraulic oil is supplied to the advanced-angle-chamber 20a via the advanced-angle-passage CS3 and the advanced-angle-side passage 101.

Accordingly, the vane rotor 10 rotates in the clockwise direction (to the advanced-angle-side) with respect to the housing rotor 20 by the biasing force of the torsion coil spring 30 and the hydraulic pressure of the hydraulic oil as illustrated in FIGS. 9 and 10.

On the other hand, in a retarded-angle-mode, a hydraulic oil in the advanced-angle-chamber 20a is discharged via the advanced-angle-passage CS3 and the advanced-angle-side passage 101, and the hydraulic oil is supplied to the retarded-angle-chamber 20b via the retarded-angle-passage CS4 and the retarded-angle-side passage 102.

Accordingly, the vane rotor 10 rotates in the counterclockwise direction (to the retarded-angle-side) with respect to the housing rotor 20 against the biasing force of the torsion coil spring 30 as illustrated in FIG. 7.

In a hold mode in which the vane rotor 10 is held at an intermediate position between the maximum-advanced-angle-position θa and the maximum-retarded-angle-position θr, the oil pressure control valve 100 is switched such that a hydraulic oil is supplied to the advanced-angle-chamber 20a and the retarded-angle-chamber 20b, and the vane rotor 10 is held at a predetermined intermediate position by the hydraulic pressure of the hydraulic oil applied to the advanced-angle-chamber 20a and the retarded-angle-chamber 20b.

With the valve timing changing device according to this embodiment, since the coil portion 31 of the torsion coil spring 30 is guided by the first inner guide portion 14 of the vane rotor 10 into which the one end 31a is inserted and is guided by the second inner guide portion 22f of the housing rotor 20 into which the other end 31b is inserted, it is possible to prevent the coil portion 31 from falling down and to stably generate a desired torque.

Accordingly, a torsion coil spring with a high torque and a high spring constant does not need to be employed to prevent the coil portion 31 from falling down and it is possible to enhance a degree of freedom in setting a torque value based on the torsion coil spring.

In the above-mentioned embodiment, a two-partition structure including the front housing 22 and the rear housing 21 with a bottomed cylindrical shape is employed as the housing rotor 20 and a configuration in which the torsion coil spring 30 is disposed between the front housing 22 and the vane rotor 10 is employed.

Accordingly, by fitting the torsion coil spring 30 and the vane rotor 10 into the front housing 22 and then coupling the front housing 22 to the rear housing 21, it is possible to easily obtain a valve timing changing device M which is a module in which the torsion coil spring 30 and the vane rotor 10 are accommodated in the housing rotor 20 as illustrated in FIG. 1.

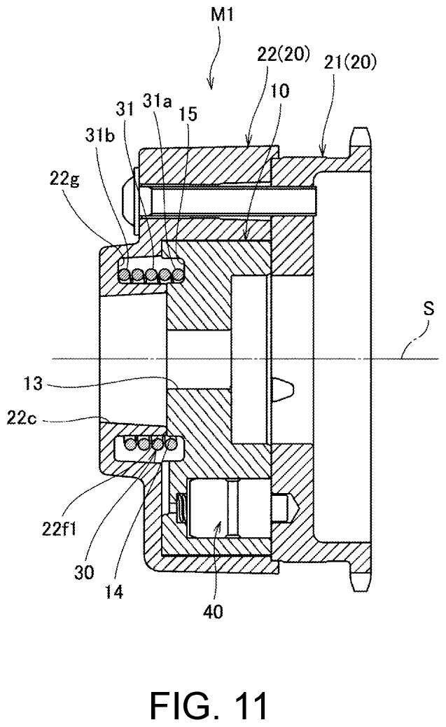

FIG. 11 illustrates another embodiment of the valve timing changing device according to the present invention, which is the same as the above-mentioned embodiment except that the second inner guide portion 22f is changed. Accordingly, the same elements will be referred to by the same reference signs and description thereof will not be repeated.

In the valve timing changing device M1 according to this embodiment, a second inner guide portion 22f1 is formed to extend in the direction of the axis S and to be in close contact with the first inner guide portion 14 in the direction of the axis S.

According to this configuration, since the second inner guide portion 22f1 and the first inner guide portion 14 are in close contact with each other, there is no gap in which the coil portion 31 falls down inward and it is possible to reliably prevent the coil portion 31 from falling down to an area through which the bolt B or the like passes.

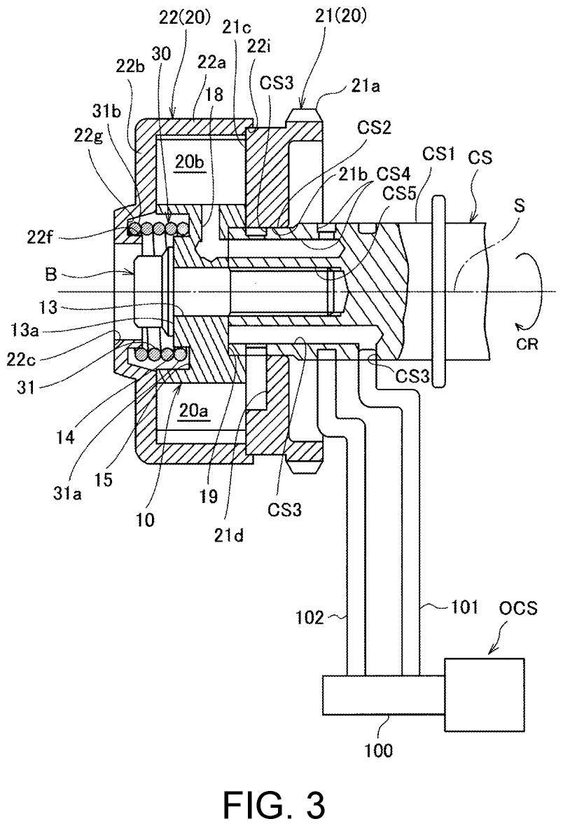

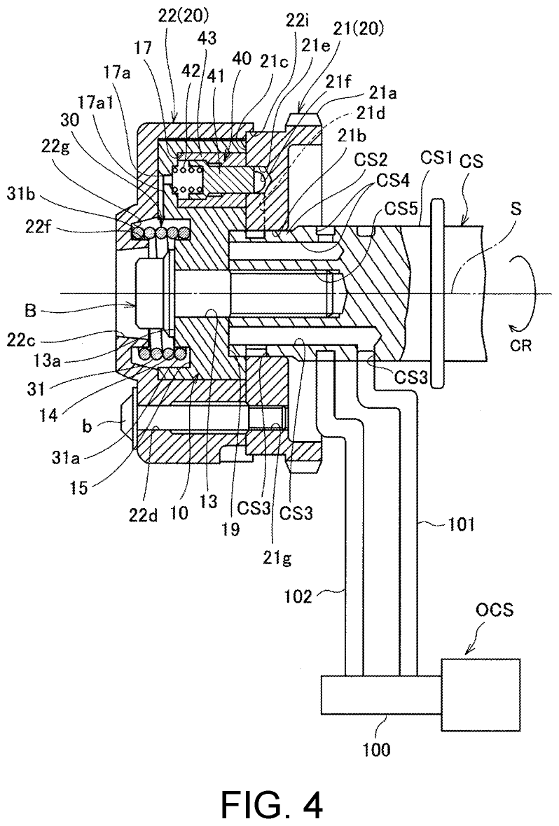

In the above-mentioned embodiments, the present invention (the first inner guide portion 14 and the second inner guide portion 22f or 22f1) is employed in a configuration in which the oil pressure control system OCS illustrated in FIGS. 3 and 4 is used as a system for controlling a flow of a hydraulic pressure, but the invention is not limited thereto. For example, the present invention may be employed as a configuration in which an oil pressure control valve incorporated into a bolt for fastening the vane rotor 10 to the cam shaft CS, a passage of a hydraulic oil corresponding thereto, and the like are employed as the oil pressure control system.

In the above-mentioned embodiments, the present invention is employed in a configuration in which the torsion coil spring 30 is set to bias the vane rotor 10 to rotate in the advanced-angle-direction relative to the housing rotor 20, but the present invention is not limited thereto. On the other hand, the present invention may be employed in a configuration in which the torsion coil spring 30 is set to bias the vane rotor to rotate in the retarded-angle-direction.

In the above-mentioned embodiments, the present invention is employed in a configuration in which the lock mechanism 40 locks the vane rotor 10 at the maximum-retarded-angle-position θr relative to the housing rotor 20, but the present invention is not limited thereto. The present invention may be employed in a configuration in which the vane rotor is locked at the maximum-advanced-angle-position θa or at an intermediate position in a predetermined angle range Δθ.

In the above-mentioned embodiments, the seat surface 22g1 is formed to be located on a spiral-shaped inclined surface with a predetermined angle in the second ring-shaped concave portion 22g of the housing rotor 20, but the present invention is not limited thereto. The seat surface may be similarly formed to be located on a spiral-shaped inclined surface with a predetermined angle in the first ring-shaped concave portion 15 of the vane rotor 10.

In the above-mentioned embodiments, the housing rotor 20 having a two-partition structure including the rear housing 21 and the front housing 22 is provided as a housing rotor, but the present invention is not limited thereto. For example, the present invention may be employed in a configuration including a housing rotor having a three-partition structure including a front housing having a flat panel shape, a circumferential housing having a cylindrical shape, and a rear housing having a flat panel shape or another structure.

In the above-mentioned embodiments, the housing rotor 20 including the sprocket 21a is provided as a driven portion for transmitting a rotational force of the crank shaft, but the present invention is not limited thereto. For example, when a means for transmitting a rotational driving force of the crank shaft has another structure, for example, a toothed timing belt, a housing rotor including a toothed pulley corresponding to the structure can be employed.

In the above-mentioned embodiments, the lock mechanism including the lock pin 41, the coil spring 42, and the cylindrical holder 43 and having a configuration for locking the vane rotor at the maximum-retarded-angle-position is provided, but the present invention is not limited thereto. For example, as long as it has a configuration capable of locking the vane rotor 10 to the housing rotor 20, another lock mechanism may be employed. The locked position is not limited to the maximum-retarded-angle-position and may be a maximum advanced-angle-position or another position if necessary.

As described above, since the valve timing changing device according to the present invention can prevent a torsion coil spring from falling down or the like and ensure an expected function, the valve timing changing device can be applied to an internal combustion engine which is mounted in an automobile or the like and be usefully used in a small-size engine which is mounted in a motorcycle with two wheels or the like.

### REFERENCE SIGNS LIST

CS Cam shaft
S1 Axis
M, M1 Valve timing changing device
10 Vane rotor
13 Through-hole
13a Seat surface
14 First inner guide portion
15 First ring-shaped concave portion
16 Second locking recessed portion
20 Housing rotor
21 Rear housing
22 Front housing
22c Opening
22d Through-hole
22f, 22f1 Second inner guide portion
22g Second ring-shaped concave portion
22g1 Seat surface
22h Second locking recessed portion
30 Torsion coil spring
31 Coil portion
31a One end of coil portion
31b Other end of coil portion
32 First arm
33 Second arm
B Bolt

1. A valve timing changing device that changes an opening/closing timing of an intake valve or an exhaust valve which is driven by a cam shaft, comprising:
a vane rotor that is connected to the cam shaft to integrally rotate with the cam shaft about a same axis;
a housing rotor that accommodates the vane rotor and is capable of relative rotation in a predetermined angle range about the axis; and
a torsion coil spring that includes a coil portion such that the coil portion biases the vane rotor to rotate in one direction relative to the housing rotor,
the vane rotor including a first inner guide portion that is inserted into the coil portion from one end of the coil portion, and
the housing rotor including a second inner guide portion that is inserted into the coil portion from the other end of the coil portion.

2. The valve timing changing device according to claim 1, wherein the first inner guide portion and the second inner guide portion are configured to have a cylindrical outer circumferential surface.

3. The valve timing changing device according to claim 1, wherein the housing rotor includes an opening through which a bolt for fastening the vane rotor to the cam shaft passes and includes the second inner guide portion around the opening, and
wherein the vane rotor includes a through-hole through which the bolt passes and includes the first inner guide portion around the through-hole.

4. The valve timing changing device according to claim 3, wherein the vane rotor includes a first ring-shaped concave portion that receives one end of the coil portion around the first inner guide portion, and
wherein the housing rotor includes a second ring-shaped concave portion that receives the other end of the coil portion around the second inner guide portion.

5. The valve timing changing device according to claim 4, wherein the second ring-shaped concave portion or the first ring-shaped concave portion is configured such that a seat surface for receiving the coil portion is located on a spiral-shaped inclined surface with a predetermined angle.

6. The valve timing changing device according to claim 3, wherein the torsion coil spring includes a first arm that extends inward in a radial direction from the coil portion and a second arm that extends outward in the radial direction from the coil portion,
wherein the vane rotor includes a first locking recessed portion that locks the first arm in an area which is visible via the opening of the housing rotor, and
wherein the housing rotor includes a second locking recessed portion that locks the second arm around the opening.

7. The valve timing changing device according to claim 1, wherein the torsion coil spring is set to be closest to the first inner guide portion and the second inner guide portion in a state in which the torsion coil spring is twisted a predetermined quantity and a coil diameter of the coil portion is decreased.

8. The valve timing changing device according to claim 1, wherein the second inner guide portion and the first inner guide portion are configured to be in close contact with each other in a direction of the axis.

9. The valve timing changing device according to claim 3, wherein the housing rotor includes a front housing that has a bottom and the opening and a rear housing that is coupled to the front housing in a direction of the axis, and
wherein the torsion coil spring is disposed between the front housing and the vane rotor.

10. The valve timing changing device according to claim 2, wherein the housing rotor includes an opening through which a bolt for fastening the vane rotor to the cam shaft passes and includes the second inner guide portion around the opening, and
wherein the vane rotor includes a through-hole through which the bolt passes and includes the first inner guide portion around the through-hole.

11. The valve timing changing device according to claim 10, wherein the vane rotor includes a first ring-shaped concave portion that receives one end of the coil portion around the first inner guide portion, and
wherein the housing rotor includes a second ring-shaped concave portion that receives the other end of the coil portion around the second inner guide portion.

12. The valve timing changing device according to claim 5, wherein the torsion coil spring includes a first arm that extends inward in a radial direction from the coil portion and a second arm that extends outward in the radial direction from the coil portion,
wherein the vane rotor includes a first locking recessed portion that locks the first arm in an area which is visible via the opening of the housing rotor, and
wherein the housing rotor includes a second locking recessed portion that locks the second arm around the opening.

13. The valve timing changing device according to claim 10, wherein the torsion coil spring includes a first arm that extends inward in a radial direction from the coil portion and a second arm that extends outward in the radial direction from the coil portion,
wherein the vane rotor includes a first locking recessed portion that locks the first arm in an area which is visible via the opening of the housing rotor, and
wherein the housing rotor includes a second locking recessed portion that locks the second arm around the opening.

14. The valve timing changing device according to claim 12, wherein the torsion coil spring is set to be closest to the first inner guide portion and the second inner guide portion in a state in which the torsion coil spring is twisted a predetermined quantity and a coil diameter of the coil portion is decreased.

15. The valve timing changing device according to claim 7, wherein the second inner guide portion and the first inner guide portion are configured to be in close contact with each other in a direction of the axis.

16. The valve timing changing device according to claim 14, wherein the second inner guide portion and the first inner guide portion are configured to be in close contact with each other in a direction of the axis.

17. The valve timing changing device according to claim 8, wherein the housing rotor includes a front housing that has a bottom and the opening and a rear housing that is coupled to the front housing in a direction of the axis, and
wherein the torsion coil spring is disposed between the front housing and the vane rotor.

18. The valve timing changing device according to claim 10, wherein the housing rotor includes a front housing that has a bottom and the opening and a rear housing that is coupled to the front housing in a direction of the axis, and
wherein the torsion coil spring is disposed between the front housing and the vane rotor.

19. The valve timing changing device according to claim 15, wherein the housing rotor includes a front housing that has a bottom and the opening and a rear housing that is coupled to the front housing in a direction of the axis, and
wherein the torsion coil spring is disposed between the front housing and the vane rotor.

20. The valve timing changing device according to claim 16, wherein the housing rotor includes a front housing that has a bottom and the opening and a rear housing that is coupled to the front housing in a direction of the axis, and
wherein the torsion coil spring is disposed between the front housing and the vane rotor.
